(19) United States
(12) Patent Application Publication
(10) Pub. No.: US 2013/0235310 A1
(43) Pub. Date: Sep. 12, 2013

(54) LCD Panel and LCD Device

(71) Applicant: Guofu Tang, Shenzhen (CN)

(72) Inventor: Guofu Tang, Shenzhen (CN)

(21) Appl. No.: 13/500,821

(22) PCT Filed: Mar. 26, 2012
(86) PCT No.: PCT/CN2012/073021

§ 371 Date: Apr. 6, 2012

(30) Foreign Application Priority Data
Mar. 6, 2012 (CN) 201210056973.8

(51) Int. Cl. G02F 1/1337; G02F 1/1335

(52) U.S. Cl. 349/106; 349/123

(57) ABSTRACT

The invention relates to the field of LCDs, and more particularly to an LCD panel and an LCD device. The LCD panel includes a glass substrate; the glass substrate is coated with a PI layer, and the end of the PI layer is provided with closely distributed and mutually independent retaining wall sections. The distance of the end of the PI liquid is controlled by arranging the closely distributed and mutually independent retaining wall sections. The distance between the end of the PI layer and the frame sealant can be reduced when the liquid of the frame sealant is coated, and the design of narrow frames can be achieved because the distance between the visual domain and the end of the PI layer and the distance between the end of the PI layer and the frame sealant are shortened.

### TECHNICAL FIELD

The invention relates to the field of liquid crystal displays (LCDs), and more particularly to an LCD panel and an LCD device.

### BACKGROUND

LCDs are widely applied in recent years because of the advantages of low power consumption, low cost manufacture, and no radiation, etc. An LCD panel mainly includes a color filter (CF) glass substrate and an array glass substrate which are arranged opposite to each other, and a liquid crystal layer arranged between the two substrates. As shown in FIG. 1, the CF glass substrate 1 is coated with a transparent conductive glass layer, namely indium tin oxide (ITO) layer 4, and then a polyimide (PI) layer 3 is coated onto the ITO layer. The PI layer 3 is used for liquid crystal alignment to give an initial angle to liquid crystal molecules. In addition, the array substrate 2 is also provided with a PI layer 3 having the same function. The manufacture process of the PI layer generally employs a liquid flow mode. The terminal domain of the PI liquid is not easy to control. Conventionally, the design value of the distance D1 between the edge of the visual domain and the end of the PI layer is large to ensure that the edge of the visual domain has complete liquid crystal alignment and avoid that the edge of the visual domain has poor quality. The upper substrate and the lower substrate are supported and stuck by a frame sealant. The width D3 of the frame sealant has no compression space in general. If the frame sealant is coated onto the PI layer, the area of the glass substrate stuck by the frame sealant is reduced, and then the sticking force is affected, thereby causing the risk of poor glass substrate stability; thus, the distance D2 between the end of the PI layer and the frame sealant cannot be further reduced. Because of the limitation of the aforementioned traditional process, the distance between the visual domain and the edge of the glass substrate cannot be further narrowed, and then the design of narrower frames cannot be achieved.

### SUMMARY

The aim of the invention is to break the limitation of the traditional process and provide an LCD panel and an LCD device with a narrow frame.

A first technical scheme of the invention is that: an LCD panel comprises a glass substrate; the glass substrate is coated with a PI layer, and one end of the PI layer is provided with closely distributed and mutually independent retaining wall sections. The interval between the adjacent retaining wall sections is less than or equal to the thickness of the PI layer, the height of the retaining wall sections is more than the thickness of the PI layer, and the cross section of the retaining wall sections is in a rectangle, trapezoid, semicircle, or inverted U shape. The glass substrate is a CF substrate, the CF substrate is coated with an ITO layer, and the PI layer is coated onto the ITO layer.

A second technical scheme of the invention is that: an LCD panel comprises a glass substrate; the glass substrate is coated with a PI layer, and one end of the PI layer is provided with closely distributed and mutually independent retaining wall sections.

Preferably, obvious end control effect can be obtained when the interval between the adjacent retaining wall sections is less than or equal to the thickness of the PI layer.

Preferably, better end control effect can be obtained when the height of the retaining wall sections is more than the thickness of the PI layer.

Preferably, better end control effect can be obtained when the height of the retaining wall sections is less than or equal to the thickness of the PI layer.

Preferably, the cross section of the retaining wall sections is in a rectangle, trapezoid, semicircle, or inverted U shape.

Preferably, the glass substrate is a CF substrate, the CF substrate is coated with an ITO layer, and the PI layer is coated onto the ITO layer.

Preferably, the glass substrate is an array substrate.

The invention further provides a third technical scheme. An LCD device comprises an LCD panel; the LCD panel comprises a glass substrate, the glass substrate is coated with a PI layer, and one end of the PI layer is provided with closely distributed and mutually independent retaining wall sections.

Preferably, the interval between the adjacent retaining wall sections is less than or equal to the thickness of the PI layer.

Preferably, the height of the retaining wall sections is more than the thickness of the PI layer.

Preferably, the height of the retaining wall sections is less than or equal to the thickness of the PI layer.

Preferably, the cross section of the retaining wall sections is in a rectangle, trapezoid, semicircle, or inverted U shape.

Preferably, the glass substrate is a CF substrate, the CF substrate is coated with an ITO layer, and the PI layer is coated onto the ITO layer.

Preferably, the glass substrate is an array substrate.

Advantages of the invention are summarized below: the closely distributed and mutually independent retaining wall sections of the invention have the following working principle: when the PI liquid flows, before the PI liquid is in contact with the retaining wall sections, the flow is controlled by the internal force of the liquid; after the PI liquid is in contact with the retaining wall sections, less PI liquid enters the interval because of the small interval between two retaining wall sections, thereby reducing the internal force of the liquid in accordance with the principle of surface tension; when the internal force of the liquid is equal to the outside atmospheric pressure, the liquid stops flowing, thereby reducing the distance between the visual domain and the end of the PI layer.

In the invention, the end distance of the PI liquid is controlled by arranging the closely distributed and mutually independent retaining wall sections. The distance between the end of the PI layer and the frame sealant can be narrowed when the liquid of the frame sealant is coated. The frame sealant can be coated closely to the end of the PI layer because the end of the PI layer is controlled accurately. Although interference may exist between the frame sealant and the retaining wall sections, because there are intervals between the retaining wall sections, a part of frame sealant is still in contact with the glass, thus the sticking force cannot be significantly reduced. Because the distance between the visual domain and the end of the PI layer and the distance between the end of the PI layer and the frame sealant are shortened, the design of narrow frames can be achieved.

### BRIEF DESCRIPTION OF FIGURES

FIG. 1 is a structure diagram of an LCD panel in the prior art;

FIG. 2 is a structure diagram of an LCD panel of an example of the invention;

FIG. 3 is a structure diagram of a retaining wall section with a rectangle cross section of the invention; and

FIG. 4 is a structure diagram of a retaining wall section with an inverted U-shaped cross section of the invention.

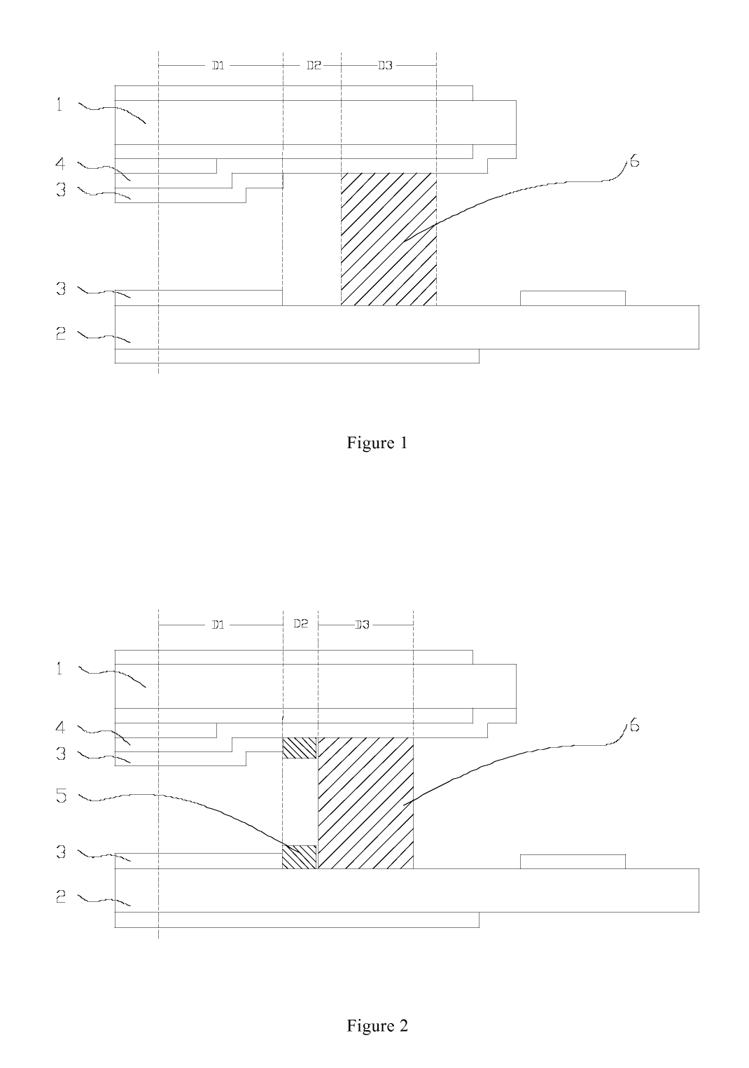

Legends: 1 CF substrate; 2. array substrate; 3. PI layer; 4. ITO layer; 5. retaining wall section; 6. frame sealant.

### DETAILED DESCRIPTION

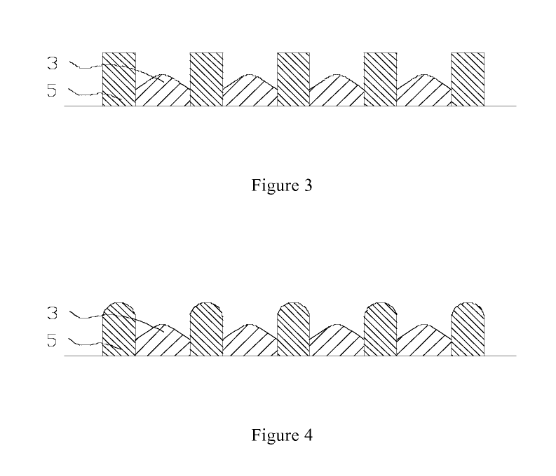

The invention provides an LCD device comprising an LCD panel. An example of the LCD panel of the invention is shown in FIG. 2 and FIG. 3. The LCD panel comprises an upper glass substrate and a lower glass substrate; one glass substrate is a CF substrate 1, the CF substrate 1 is coated with an ITO layer 4, and a PI layer 3 is coated onto the ITO layer 4; the other glass substrate is an array substrate 2, the array substrate 2 is coated with a PI layer 3, the end of the PI layer 3 is provided with closely distributed and mutually independent retaining wall sections 5, and the retaining wall sections 5 in the example are linearly arranged.

The closely distributed and mutually independent retaining wall sections 5 of the invention have the following working principle: when the PI liquid flows, before the PI liquid is in contact with the retaining wall sections, the flow is controlled by the internal force of the liquid; after the PI liquid is in contact with the retaining wall sections, less PI liquid enters the interval because of the small interval between two retaining wall sections, thereby reducing the internal force of the liquid in accordance with the principle of surface tension; when the internal force of the liquid is equal to the outside atmospheric pressure, the liquid stops flowing, thereby, reducing the distance D1 between the visual domain and the end of the PI layer.

The end distance of the PI liquid is controlled by arranging the closely distributed and mutually independent retaining wall sections 5. The distance D2 between the end of the PI layer and the frame sealant can be reduced when the liquid of the frame sealant 6 is coated. The frame sealant 6 can be coated close to the PI end because the end of the PI layer is controlled accurately. Although interference may exist between the frame sealant 6 and the retaining wall sections 5, because there are intervals between the retaining wall sections 5, a part of frame sealant 6 is still in contact with the glass substrate, thus the sticking force cannot be significantly reduced. Because the distance D1 between the visual domain and the end of the PI layer and the distance D2 between the end of the PI layer and the frame sealant are shortened, the design of narrow frames can be achieved.

In the example, the cross section of the retaining wall sections 5 is in a rectangle shape; optionally, the cross section of the retaining wall sections 5 can be in other shapes such as inverted U shape, trapezoid, semicircle, etc.

In the invention, obvious end control effect can be obtained when the height of the retaining wall sections 5 is less than or equal to the thickness of the PI layer 3; better end control effect can be obtained when the interval between the adjacent retaining wall sections 5 is less than or equal to the thickness of the PI layer 3, and the height of the retaining wall sections 5 is more than the thickness of the PI layer 3.

The retaining wall sections of the invention can be arranged on the glass substrate by the following steps: coating a photoresistive layer onto the glass substrate; putting the glass substrate into an oven and prebaking the photoresistive layer so that the upper surface of the photoresistive layer is solidified; exposing the photoresistive layer of which the upper surface is already solidified by a light shield; and developing and etching the photoresistive layer. In the example, the photoresistive layer comprises a UV photopolymer and a thermosetting polymer.

The retaining wall sections of the invention are not only used for controlling the end of the PI liquid, but also used for controlling the end of a film manufactured by applying flowing liquid.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD panel, comprising: a glass substrate; wherein said glass substrate is coated with a PI layer, and one end of said PI layer is provided with closely distributed and mutually independent retaining wall sections; the distance between said adjacent retaining wall sections is less than or equal to the thickness of said PI layer, the height of said retaining wall sections is more than the thickness of said PI layer, and the cross section of said retaining wall sections is in a rectangle, trapezoid, semicircle, or inverted U shape; said glass substrate is a CF substrate, the CF substrate is coated with an ITO layer, and the PI layer is coated onto the ITO layer.

2. An LCD panel, comprising: a glass substrate; wherein said glass substrate is coated with a PI layer, and one end of said PI layer is provided with closely distributed and mutually independent retaining wall sections.

3. The LCD panel of claim 2, wherein the interval between said adjacent retaining wall sections is less than or equal to the thickness of said PI layer.

4. The LCD panel of claim 2, wherein the height of said retaining wall sections is more than the thickness of said PI layer.

5. The LCD panel of claim 2, wherein the height of said retaining wall sections is less than or equal to the thickness of said PI layer.

6. The LCD panel of claim 2, wherein the cross section of said retaining wall sections is in a rectangle, trapezoid, semicircle or inverted U shape.

7. The LCD panel of claim 2, wherein said glass substrate is a CF substrate, the CF substrate is coated with an ITO layer, and the PI layer is coated onto the ITO layer.

8. The LCD panel of claim 2, wherein said glass substrate is an array substrate.

9. An LCD device, comprising: an LCD panel; wherein said LCD panel comprises a glass substrate; said glass substrate is coated with a PI layer, and one end of said PI layer is provided with closely distributed and mutually independent retaining wall sections.

10. The LCD device of claim 9, wherein the interval between said adjacent retaining wall sections is less than or equal to the thickness of said PI layer.

11. The LCD device of claim 9, wherein the height of said retaining wall sections is more than the thickness of said PI layer.

12. The LCD device of claim 9, wherein the height of said retaining wall sections is less than or equal to the thickness of said PI layer.

13. The LCD device of claim 9, wherein the cross section of said retaining wall sections is in a rectangle, trapezoid, semicircle, or inverted U shape.

14. The LCD device of claim 9, wherein said glass substrate is a CF substrate, the CF substrate is coated with an ITO layer, and the PI layer is coated onto the ITO layer.

15. The LCD device of claim 9, wherein said glass substrate is an array substrate.
